(19) United States
(12) Patent Application Publication
(10) Pub. No.: US 2018/0231692 A1
(43) Pub. Date: Aug. 16, 2018

(54) WINDOW FOR DISPLAY DEVICE AND METHOD OF MANUFACTURING THE SAME AND DISPLAY DEVICE

(71) Applicant: SAMSUNG ELECTRONICS CO., LTD., Suwon-si (KR)

(72) Inventors: Cheol HAM, Yongin-si (KR); Jun Cheol BAE, Suwon-si (KR); Nak Hyun KIM, Yongin-si (KR)

(21) Appl. No.: 15/815,928

(22) Filed: Nov. 17, 2017

(30) Foreign Application Priority Data
Feb. 15, 2017 (KR) 10-2017-0020536

(51) Int. Cl. G02B 1/14; C08G 77/50; C08K 5/54; C08L 83/06; C08G 18/63

(52) U.S. Cl. CPC G02B 1/14; C08G 77/50; C08G 18/635; C08L 83/06; C08K 5/54

(57) ABSTRACT

A window for a display device includes a polymer substrate, a first protective layer on the polymer substrate and including a cured product of a multi-functional urethane (meth)acrylate compound having six or more (meth)acrylate groups and a second protective layer on the first protective layer and including a cured product of epoxy-containing polysilsesquioxane, wherein the second protective layer is thicker than the first protective layer, and a thickness of the first protective layer ranges from about 0.1 μm to about 10 μm and a thickness of the second protective layer ranges from about 5 μm to about 30 μm, and a method of manufacturing the same and a display device including a window for a display device.

### CROSS-REFERENCE TO RELATED APPLICATION

This application claims priority to and the benefit of Korean Patent Application No. 10-2017-0020536, filed in the Korean Intellectual Property Office on Feb. 15, 2017, and all the benefits accruing therefrom under 35 U.S.C. § 119, the entire content of which is incorporated herein in its entirety by reference.

### BACKGROUND

### 1. Field

A window for a display device, a method of manufacturing the same, and a display device are disclosed.

### 2. Description of the Related Art

As specifications for portable electronic devices such as a smart phone or a tablet personal computer (PC) become more diversified, the display device thereof may be required to be bendable, foldable, or flexibility as well as to be slim and light-weight.

Currently, the display device mounted in the portable electronic device may include a rigid glass for protecting a display module.

However, the glass may lack flexibility and may not appropriately be applied to a flexible display device.

Thus, a plastic film may be substituted for the glass.

### SUMMARY

An embodiment provides a window for a display device having improving mechanical characteristics while being flexible.

An embodiment provides a method of manufacturing the window for a display device.

An embodiment provides a display device including the window for a display device.

According to an embodiment, a window for a display device includes polymer substrate, a first protective layer disposed on the polymer substrate and including a cured product of a multi-functional urethane (meth)acrylate compound having six or more (meth)acrylate groups, and a second protective layer disposed on the first protective layer and including a cured product of epoxy-containing polysilsesquioxane, wherein the second protective layer is thicker than the first protective layer, and a thickness of the first protective layer ranges from about 0.1 micrometers (μm) to about 10 μm and a thickness of the second protective layer ranges from about 5 μm to about 30 μm.

The first protective layer may further include an inorganic nanostructure.

The inorganic nanostructure may be chemically bonded in the cured product of the multi-functional urethane(meth)acrylate compound.

The multi-functional urethane (meth)acrylate compound may have nine or more (meth)acrylate groups.

The first protective layer may include a silicon leveling agent or a cured product thereof.

The epoxy-containing polysilsesquioxane may include a glycidyl group, a glycidoxy group, an epoxy cyclohexyl group, an oxetanyl group, or a combination thereof.

The second protective layer may include a fluorine leveling agent or a cured product thereof.

A sum of thicknesses of the first protective layer and the second protective layer may be about 10 μm to about 30 μm.

A thickness of the first protective layer may range from about 2 μm to about 5 μm and a thickness of the second protective layer may range from about 7 μm to about 30 μm.

The polymer substrate may include polyimide, polyamide, polyamideimide, polyethylene terephthalate, polyethylene naphthalate, polymethyl methacrylate, polycarbonate, a copolymer thereof, or a combination thereof.

The polymer substrate may have a thickness of about 25 μm to 100 μm.

According to an embodiment, a method of manufacturing a window for a display device includes coating a first composition including a multi-functional urethane (meth)acrylate compound having six or more (meth)acrylate groups, a first reaction initiator, and a first solvent on a polymer substrate and curing the first composition to form a first protective layer and coating a second composition including an epoxy-containing polysilsesquioxane, a second reaction initiator, and a second solvent on the first protective layer and curing the second composition to form a second protective layer, wherein the second protective layer is thicker than the first protective layer, and a thickness of the first protective layer ranges from about 0.1 μm to about 10 μm and a thickness of the second protective layer ranges from about 5 μm to about 30 μm.

The first composition may further include a (meth)acryl modified inorganic nanostructure.

The first composition may further include a silicon leveling agent.

The second composition may further include a fluorine leveling agent.

The multi-functional urethane (meth)acrylate compound may include nine or more (meth)acrylate groups and the epoxy-containing polysilsesquioxane may include a glycidyl group, a glycidoxy group, an epoxy cyclohexyl group, an oxetanyl group, or a combination thereof.

According to an embodiment, a display device includes a display panel and the window for a display device.

The display panel may be an organic light emitting panel or a liquid crystal panel.

The display panel may be a bendable display panel, a foldable display panel, or a rollable display panel.

The display device may further include a touch panel disposed between the display panel and the window for a display device.

By providing a window for a display device simultaneously satisfying the flexibility and the impact resistance, the window may be effectively applied to a bendable, foldable, or rollable display device.

### BRIEF DESCRIPTION OF THE DRAWINGS

FIG. 1 is a cross-sectional view showing an embodiment of a window for a display device;

FIG. 2 is a cross-sectional view of an embodiment of a display device; and

FIG. 3 is a cross-sectional view of an embodiment of a display device.

### DETAILED DESCRIPTION

Exemplary embodiments will hereinafter be described in detail, and may be easily realized by a person having an ordinary skill in the art.

However, actually applied structures may be embodied in many different forms and is not construed as limited to the exemplary embodiments set forth herein.

In the drawings, the thickness of layers, films, panels, regions, etc., are exaggerated for clarity.

Like reference numerals designate like elements throughout the specification.

It will be understood that when an element such as a layer, film, region, or substrate is referred to as being “on” another element, it can be directly on the other element or intervening elements may also be present.

In contrast, when an element is referred to as being “directly on” another element, there are no intervening elements present.

Hereinafter, “combination” refers to a mixture of two or more and a stack structure of two or more.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. “(Meth)acryl” as used herein is inclusive of both methacryl (H₂C═C(CH₃)C(═O)—) and acryl (H₂C═CHC(═O)—) groups.

Hereinafter, a window for a display device according to an embodiment is described.

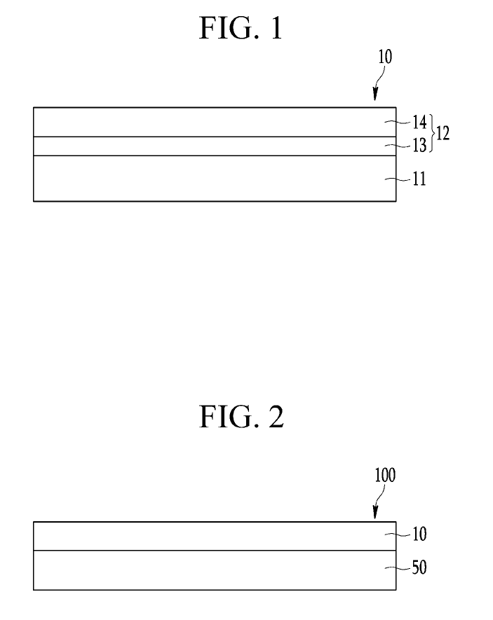

FIG. 1 is a cross-sectional view showing a window for a display device according to an embodiment.

Referring to FIG. 1, a window 10 for a display device according to an embodiment includes a substrate 11 and a protective layer 12 disposed on the substrate 11.

The substrate 11 may be a polymer substrate, for example a transparent polymer substrate.

The substrate 11 may include for example polyimide, polyamide, polyamideimide, polyethylene terephthalate, polyethylene naphthalate, polymethyl methacrylate, polycarbonate, a copolymer thereof, or a combination thereof, but is not limited thereto.

The substrate 11 may have for example a light transmittance of greater than or equal to about 85% and a yellow index (YI) of less than or equal to about 3.0.

The substrate 11 may have for example a thickness of about 25 μm to about 100 μm.

Within the range, the substrate may have for example a thickness of about 30 μm to about 80 μm.

The protective layer 12 may be disposed on the substrate 11 to protect the window 10 for a display device from mechanical, e.g., physical, damage.

The protective layer 12 may be for example a hard coating layer, a scratch resistance layer, or a very hard layer.

The protective layer 12 includes a lower protective layer 13 and an upper protective layer 14.

The lower protective layer 13 may include a cured product of a multi-functional urethane (meth)acrylate compound having six or more (meth)acrylate groups.

The multi-functional urethane (meth)acrylate compound may have for example seven or more (meth)acrylate groups, for example eight or more (meth)acrylate groups or nine or more (meth)acrylate groups.

The multi-functional urethane (meth)acrylate compound may be any compound including a urethane moiety (i.e., —NH—C(═O)—O—) and six or more (meth)acryloyl groups without particular limit, and may be a monomer, an oligomer, and/or a polymer.

For example, the multi-functional urethane (meth)acrylate compound may be a reaction product of an isocyanate compound and a (meth)acrylate compound having a hydroxy group. The isocyanate compound can have, for example 3 to 60 or 5 to 30 carbon atoms.

The isocyanate compound may be for example an aliphatic diisocyanate compound such as hexamethylene diisocyanate; an alicyclic diisocyanate compound such as bis(isocyanatomethyl)cyclohexane, norbornane diisocyanate, isophorone diisocyanate, dicyclohexylmethane diisocyanate, and the like, or a combination thereof, but is not limited thereto.

The (meth)acrylate compound having the hydroxy group may include for example hydroxyethyl (meth)acrylate, hydroxypropyl (meth)acrylate, trimethylolpropane (meth)acrylate, dipentaerythritol hexa(meth)acrylate, or a combination thereof, but is not limited thereto.

A weight average molecular weight of the multi-functional urethane (meth)acrylate compound may range from about 1,000 grams per mole (g/mol) to about 50,000 g/mol, for example about 1,500 g/mol to about 40,000 g/mol, or about 2,000 to about 30,000 g/mol.

The lower protective layer 13 may further include a nanostructure.

The nanostructure may be for example a nano-level structure including an inorganic material, an organic material, or an organic/inorganic material and may be a one-dimensional, two-dimensional, and/or three-dimensional shaped nanostructure.

The nanostructure may include for example a nanoparticle, a nanorod, a nanoplate, a nanowire, a nanoflake, a nanotube, a nanocapsule, or a combination thereof, but is not limited thereto.

For example, the nanostructure may be an inorganic nanoparticle, an inorganic nanorod, an inorganic nanoplate, an inorganic nanowire, an inorganic nanoflake, an inorganic nanotube, an inorganic nanocapsule, or a combination thereof, but is not limited thereto.

The nanostructure may be for example an oxide, a nitride, or an oxynitride, and may be for example a metal oxide, a semi-metal oxide, a metal nitride, a semi-metal nitride, a metal oxynitride, or a semi-metal oxynitride.

The nanostructure may include for example SiO₂, Al₂O₃, TiO₂, ZrO₂, BaTiO₃, SrTiO₃, Cu₂O, CuO, Cr₂O₃, Fe₂O₃, Mn₃O₄, MnO₂, NiO, ZnO, or a combination thereof, but is not limited thereto.

The nanostructure may have for example a long diameter of less than or equal to about 200 nanometers (nm), for example a long diameter of about 5 nm to about 180 nm, about 10 nm to about 150 nm, or about 5 nm to about 100 nm.

Herein, the long diameter may be a particle diameter in case of a spherical shape and the long diameter may be a length of the longest part of a height, a width, and a thickness in case of a non-spherical shape, e.g., a nanorod.

For example, the nanostructure may be an inorganic nanostructure modified with an organic group, for example an inorganic nanostructure modified with a (meth)acryl group.

For example, the inorganic nanostructure modified with an organic group may react with the multi-functional urethane(meth)acrylate by being cured, and accordingly the inorganic nanostructure may be chemically bonded in the cured product of the multi-functional urethane(meth)acrylate.

The lower protective layer 13 may further include a leveling agent or a cured product thereof, and may further include for example a silicon leveling agent (i.e., a leveling agent containing silicon) or a cured product thereof.

The silicon leveling agent may be for example a silane compound and/or a siloxane compound and may include for example a functional group such as (meth)acrylate at a terminal end.

The silicon leveling agent may further improve a coating property and a close contacting property of the lower protective layer 13 on the substrate 11. In an embodiment, the silicone leveling agent may improve an adhesive property of the lower protective layer 13 on the substrate 11.

The lower protective layer 13 may have for example a thickness of about 0.1 μm to about 10 μm, for example about 1 μm to about 8 μm, or about 2 μm to about 5 μm.

The upper protective layer 14 may include a cured product of epoxy-containing polysilsesquioxane.

The epoxy-containing polysilsesquioxane may have at least one epoxy group, for example at least one aliphatic cyclic epoxy group, and may be for example polysilsesquioxane including a glycidyl group, a glycidoxy group, an epoxy cyclohexyl group, an oxetanyl group, or a combination thereof.

An epoxy group equivalent of the epoxy-containing polysilsesquioxane may be for example about 1 millimole/gram (mmol/g) to about 15 mmol/g or about 2 mmol/g to about 10 mmol/g.

A weight average molecular weight of the epoxy-containing polysilsesquioxane may be about 500 to about 5,000, for example about 1,000 to about 4,000 or about 1,200 to about 3,000.

The upper protective layer 14 may further include a leveling agent or a cured product thereof, for example a fluorine leveling agent (i.e., a leveling agent containing fluorine) or a cured product thereof.

The fluorine leveling agent may further improve a coating property and a close contacting property on the lower protective layer 13, or an adhesive-promoting property.

The upper protective layer 14 may be thicker than the lower protective layer 13.

The upper protective layer 14 may have a thickness of about 3 μm to about 30 μm, for example about 5 μm to about 30 μm.

For example, a thickness of the lower protective layer may range from about 0.1 μm to about 10 μm and a thickness of the upper protective layer may range from about 5 μm to about 30 μm.

A sum of thicknesses of the lower protective layer 13 and the upper protective layer 14 may be about 6 μm to about 40 μm, for example about 8 μm to about 35 μm or about 10 μm to about 30 μm.

Within such thickness ranges, flexibility and mechanical characteristics may be further effectively satisfied.

A window 10 for a display device according to an embodiment may improve mechanical strength and a close contacting property of the window 10 for a display device simultaneously by forming a lower protective layer 13 including a cured product of a multi-functional urethane (meth)acrylate compound having six or more (meth)acrylate groups and an upper protective layer 14 including a cured product of epoxy-containing polysilsesquioxane sequentially on the substrate 11. An adhesive property of the window 10 may therefore be improved.

Accordingly, the window 10 for a display device may have high surface hardness and scratch resistance characteristics as well as flexibility and may reduce undesired bending, e.g., formation of a V-shape, delamination, or peeling off during processes and/or uses.

Hereinafter, a method of manufacturing a window for a display device is for example described.

A method of manufacturing a window for a display device according to an embodiment includes coating a composition for a lower protective layer and curing the coated composition for the lower protective layer to form a lower protective layer on the substrate 11 and coating a composition for an upper protective layer and curing the coated composition for the upper protective layer to form an upper protective layer on the lower protective layer.

The composition for a lower protective layer may include a multi-functional urethane (meth)acrylate compound having six or more (meth)acrylate groups, a reaction initiator, and a solvent.

The multi-functional urethane (meth)acrylate compound is the same as described above.

The multi-functional urethane (meth)acrylate compound may be included in an amount of about 30 weight percent (wt %) to about 80 wt %, for example about 30 wt % to about 70 wt % or about 40 wt % to about 60 wt % based on a total amount of the composition for a lower protective layer.

The reaction initiator may be a photopolymerization initiator or a thermal polymerization initiator.

For example, the reaction initiator may be a photopolymerization initiator, for example various benzophenones such as benzophenone, 3,3′-dimethyl-4-methoxybenzophenone, 4,4′-bisdimethylaminebenzophenone, and the like; various acyloins or their ethers such as benzoin, alpha-methylbenzoin, acetoin, butyroin, 3-hydroxy-4-methyl-2-pentanone, and tertiary butylbenzoin and the like; various xanthones such as xanthone, thioxanthone, 2-methylthioxanthone, 2-chlorothioxanthone, and the like; α-diketones such as benzil, diacetyl, 1-phenyl-1,2-propanedione, and the like; sulfides such as tetramethyl thiuram disulfide, and the like; various benzoic acids such as 4-dimethylamine benzoic acid, ethyl 4-dimethylamine benzoate, and the like; 3,3′-carbonyl-bis (7-diethyl amino)coumarin, 1-hydroxy cyclohexylphenylketone, 2,2′-dimethoxy-1,2-diphenyl ethan-1-one, 2-methyl-1-(4-(methylthio)phenyl)-2-morpholino propan-1-one, 2-benzyl-2-dimethylamino-1-(4-morpholino phenyl)-butan-1-one, 2-hydroxy-2-methyl-1-phenyl propan-1-one, 2,4,6-trimethylbenzoyldiphenylphosphine oxide, bis (2,4,6-trimethylbenzoyl)phenylphosphine oxide, 1-(4-(2-hydroxyethoxy)phenyl)-2-hydroxy-2-methyl-1-propan-1-one, 1-(4-isopropyl phenyl)-2-hydroxy-2-methyl propan-1-one, 1-(4-dodecyl phenyl)-2-hydroxy-2-methyl propan-1-one, 4-benzoyl-4′-methyldimethyl sulfide, 2,2′-diethoxy acetophenone, benzyldimethyl ketal, benzyl-β-methoxyethyl acetal, o-benzoyl methyl benzoate, bis(4-dimethyl aminophenyl)ketone, p-dimethylamino acetophenone, α, α-dichloro-4-phenoxy acetophenone, pentyl-4-dimethyl aminobenzoate, a 2-(o-chlorophenyl)-4,5-diphenylimidazolyl dimer, 2,4-bis-trichloromethyl-6-[di-(ethoxycarbonylmethyl)amino]phenyl-S-triazine, 2,4-bis-trichloromethyl-6-(4-ethoxy)phenyl-S-triazine, 2,4-bis-trichloromethyl-6-(3-bromo-4-ethoxy)phenyl-S-triazine anthraquinone, 2-t-butyl anthraquinone, 2-amyl anthraquinone, or β-chloro anthraquinone, but is not limited thereto.

The reaction initiator may be used alone or in a mixture of two or more reaction initiators.

The reaction initiator may be included in an amount of about 0.1 wt % to 20 wt %, for example about 0.1 wt % to about 10 wt % or about 0.1 wt % to about 5 wt % based on a total amount of the composition for a lower protective layer.

The solvent is not particularly limited if the solvent dissolves and/or disperses the components and may be for example water; an alcohol solvent such as methanol, ethanol, n-propyl alcohol, isopropyl alcohol, n-butanol, isobutanol, t-butanol, propylene glycol, propylene glycol methyl ether, ethylene glycol, or the like; an aliphatic hydrocarbon solvent such as hexane, heptane, or the like; an aromatic hydrocarbon solvent such as toluene, pyridine, quinoline, anisole, mesitylene, xylene, or the like; a ketone solvent such as methyl isobutyl ketone, 1-methyl-2-pyrrolidinone (NMP), cyclohexanone, acetone, or the like; an ether solvent such as tetrahydrofuran, isopropyl ether, or the like; an acetate solvent such as ethyl acetate, butyl acetate, propylene glycol methyl ether acetate, or the like; an amide solvent such as dimethyl acetamide, dimethyl formamide (DMF), or the like; a nitrile solvent such as acetonitrile, benzonitrile, or the like; or a mixture of the foregoing solvents, but is not limited thereto.

The solvent may be included in a balance amount except solid components based on a total amount of the composition for a lower protective layer (i.e., a total amount of the composition for a lower protective layer may include solid components and a balance amount of solvent).

The composition for a lower protective layer may further include a nanostructure as described above, and the nanostructure may be for example an inorganic nanostructure, for example an inorganic nanostructure modified with an organic group, for another example an inorganic nanostructure modified with a (meth)acryl group.

The nanostructure may be included in an amount of about 10 wt % to about 80 wt %, for example about 30 wt % to about 70 wt % or about 40 wt % to about 60 wt % based on a total amount of the composition for a lower protective layer.

The composition for a lower protective layer may further include a leveling agent and the leveling agent may be for example a silicon leveling agent.

The leveling agent may be included in an amount of less than or equal to about 1 wt %, for example about 0.001 wt % to about 1 wt % based on a total amount of the composition for a lower protective layer.

The composition for an upper protective layer may include an epoxy-containing polysilsesquioxane, a reaction initiator, and a solvent.

The epoxy-containing polysilsesquioxane is the same as described above.

The epoxy-containing polysilsesquioxane may be included in an amount of about 30 wt % to about 80 wt %, for example about 30 wt % to about 70 wt % or about 40 wt % to about 60 wt % based on a total amount of the composition for an upper protective layer.

The reaction initiator and the solvent are the same as described above and may be the same as or different from the reaction initiator and the solvent of the composition for a lower protective layer.

Each of the composition for a lower protective layer and the composition for an upper protective layer may be coated through a solution process, for example spin coating, slit coating, bar coating, dip coating, spray coating, inkjet printing, or the like, but is not limited thereto.

The coated composition for a lower protective layer and the coated composition for an upper protective layer may be further dried in order to remove the solvent, for example at about 70° C. to about 150° C.

The curing may be photo curing and/or thermal curing.

The photo curing may for example use a xenon lamp, a high pressure mercury lamp, a metal halide lamp, or the like and a light dose or a radiation time may be controlled as needed.

The thermal curing may be for example performed at about 80° C. to 200° C., and a heat treatment recovery and time may be controlled as needed.

After curing, additional heat treatment may be performed and the heat treatment may be for example performed at about 50° C. to about 200° C., for example about 70° C. to about 180° C. or about 80° C. to about 160° C.

The window 10 for a display device may be applied to various display devices.

The window 10 for a display device may be attached on the display panel.

Herein, the display panel and the window 10 for a display device may be directly bonded or may be bound by interposing an adhesive or a tackifier.

FIG. 2 is a cross-sectional view of a display device according to an embodiment.

Referring to FIG. 2, a display device 100 according to an embodiment includes a display panel 50 and a window 10 for a display device.

The display panel 50 may be for example an organic light emitting panel or a liquid crystal panel, for example a bendable display panel, a foldable display panel, or a rollable display panel.

The window 10 for a display device may be disposed on the side of an observer, e.g., a user, and the structure thereof is the same as described above.

The display panel 50 and the window 10 for a display device may be directly bonded or may be bound by an adhesive or a tackifier such as an optically clear adhesive (OCA).

Another layer may be further disposed between the display panel 50 and the window 10 for a display device. For example, a single layer or plural layers of a polymer layer (not shown) and optionally a transparent adhesion layer (not shown) may be further included.

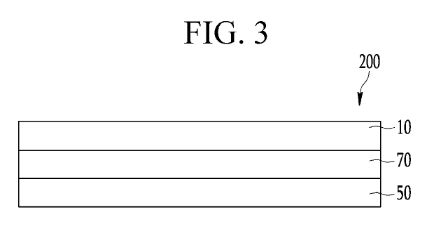

FIG. 3 is a cross-sectional view showing a display device according to an embodiment.

Referring to FIG. 3, a display device 200 according to the present embodiment includes a display panel 50, a window 10 for a display device, and a touch panel 70 disposed between display panel 50 and the window 10 for a display device.

The display panel 50 may be, for example, an organic light emitting panel or a liquid crystal panel, for example, a bendable display panel, a foldable display panel, or a rollable display panel.

The window 10 for a display device may be disposed toward an observer, e.g., user, side, and the structure is the same as described above.

The touch panel 70 may be disposed adjacent to each of the window 10 for a display device and the display panel 50 to recognize the touched position and the position change when the touch panel 70 is touched by a human hand or a material through the window 10 for a display device and then to output a touch signal.

The driving module (not shown) may monitor a position where the touch panel 70 is touched from the output touch signal; recognize an icon marked at the touched position; and control carrying out of functions corresponding to the recognized icon, and the function performance results may be expressed on the display panel 50.

Another layer may be interposed between the touch panel 70 and the window 10 for a display device. For example, a single layer or plural layers of a polymer layer (not shown) and optionally a transparent adhesion layer (not shown) may be further included.

The display device may be applied to a variety of electronic devices such as a smart phone, a tablet PC, a camera, a touch screen device, and so on, but is not limited thereto.

Hereinafter, the embodiments are illustrated in more detail with reference to examples. However, these examples are exemplary, and the present disclosure is not limited thereto.

### Preparation of Composition for Protective Layer

### PREPARATION EXAMPLE 1

20 g of urethane acrylate having nine acrylate groups (MU9800, Miwon Specialty Chemical Co., Ltd.), 67 g of an acryl modified silica dispersion solution (a silica particle diameter: 20 nm, a solid: 30 wt %, a dispersion solvent: 1-methoxy-2-propanol, NCH2020, Miwon Specialty Chemical Co., Ltd.), 1 g of a photopolymerization initiator (Irgacure 184, BASF Chemicals Co.), 0.05 g of a silicon leveling agent (BYK-3550, BYK-Chemie GmbH), and 13 g of methylisobutylketone are mixed to prepare a composition.

### PREPARATION EXAMPLE 2

50 g of glycidyl group-containing polysilsesquioxane (Glycidyl POSS®, EP0409, Hybrid Plastics Inc.), 2 g of a photopolymerization initiator (Irgacure 250, BASF Chemicals Co.), 1 g of a fluorine leveling agent (KY1203, Shin-Etsu Chemical Co., Ltd.), and 100 g of methylisobutylketone are mixed to prepare a composition.

### PREPARATION EXAMPLE 3

50 g of oxetanyl group-containing polysilsesquioxane (OX-TX100, Toagosei Co., Ltd.), 2 g of a photopolymerization initiator (Irgacure 250, BASF Chemicals Co.), 1 g of a fluorine leveling agent (KY1203, Shin-Etsu Chemical Co., Ltd.), and 100 g of methylisobutylketone are mixed to prepare a composition.

### COMPARATIVE PREPARATION EXAMPLE 1

A composition is prepared according to the same method as Preparation Example 1 except for using pentaerythritol triacrylate having three acrylate groups (M340, Miwon Specialty Chemical Co., Ltd.) instead of the urethane acrylate having nine acrylate groups.

### COMPARATIVE PREPARATION EXAMPLE 2

10 g of urethane acrylate having nine acrylate groups (MU9800, Miwon Specialty Chemical Co., Ltd.), 33 g of an acryl modified silica dispersion solution (a silica particle diameter: 20 nm, a solid: 30 wt %, a dispersion solvent: 1-methoxy-2-propanol, NCH2020, Miwon Specialty Chemical Co., Ltd.), 25 g of glycidyl group-containing polysilsesquioxane (Glycidyl FOSS®, EP0409, Hybrid Plastics Inc.), 0.5 g of a photopolymerization initiator (Irgacure 184, BASF Chemicals Co.), 1 g of a photopolymerization initiator (Irgacure 250, BASF Chemicals Co.), 1 g of a fluorine leveling agent (KY1203, Shin-Etsu Chemical Co., Ltd.), and 100 g of methylisobutylketone are mixed to prepare a composition.

### Manufacture of Window for Display Device

### EXAMPLE 1

The composition of Preparation Example 1 is bar-coated on a 50 μm-thick polyimide substrate (Kolon Industries Inc.) and dried at 90° C. for 10 minutes.

Subsequently, a 3 μm-thick lower protective layer is formed by curing the composition by radiating ultraviolet (UV) in a light dose of 300 millijoules per square centimeter (mJ/cm²) with a high pressure mercury UV lamp.

On the lower protective layer, a 10 μm-thick upper protective layer is formed by coating the composition of Preparation Example 2, drying at 90° C. for 10 minutes, and curing by ultraviolet (UV) in a light dose of 300 mJ/cm² with a high pressure mercury UV lamp to manufacture a window for a display device.

### EXAMPLE 2

A window for a display device is manufactured according to the same method as Example 1 except for forming a 25 μm-thick upper protective layer instead of the 10 μm-thick upper protective layer.

### EXAMPLE 3

A window for a display device is manufactured according to the same method as Example 1 except for using the composition of Preparation Example 3 instead of the composition of Preparation Example 2.

### COMPARATIVE EXAMPLE 1

A window for a display device is manufactured according to the same method as Example 1 except for directly forming a 10 μm-thick upper protective layer on a polyimide substrate without forming the lower protective layer.

### COMPARATIVE EXAMPLE 2

A window for a display device is manufactured according to the same method as Example 1 except for not forming the upper protective layer.

### COMPARATIVE EXAMPLE 3

A window for a display device is manufactured according to the same method as Example 1 except for forming a 3 μm-thick upper protective layer instead of the 10 μm-thick upper protective layer.

### COMPARATIVE EXAMPLE 4

A window for a display device is manufactured according to the same method as Example 1 except for forming a 35 μm-thick upper protective layer instead of the 10 μm-thick upper protective layer.

### COMPARATIVE EXAMPLE 5

A window for a display device is manufactured according to the same method as Example 1 except for forming a 15 μm-thick lower protective layer instead of the 3 μm-thick lower protective layer.

### COMPARATIVE EXAMPLE 6

A window for a display device is manufactured according to the same method as Example 1 except for using the composition of Comparative Preparation Example 1 instead of the composition of Preparation Example 1.

### COMPARATIVE EXAMPLE 7

A window for a display device is manufactured according to the same method as Example 1 except for respectively forming the lower and upper protective layers by using the composition of Preparation Example 1.

### COMPARATIVE EXAMPLE 8

The composition of Comparative Preparation Example 2 is bar-coated on a 50 μm-thick polyimide substrate (Kolon Industries Inc.) and dried at 90° C. for 10 minutes.

Subsequently, a 13 μm-thick single protective layer is formed by curing the composition by ultraviolet (UV) in a light dose of 300 mJ/cm² with a high pressure mercury UV lamp to manufacture a window for a display device.

COMPARATIVE EXAMPLE 9

The composition of Preparation Example 2 is bar-coated on a 50 μm-thick polyimide substrate (Kolon Industries Inc.) and dried at 90° C. for 10 minutes.

Subsequently, a 3 μm-thick lower protective layer is formed by radiating ultraviolet (UV) in a light dose of 300 mJ/cm² with a high pressure mercury UV lamp.

On the lower protective layer, a 10 μm-thick upper protective layer is formed by car-coating the composition of Preparation Example 1, drying at 90° C. for 10 minutes, and curing by ultraviolet (UV) with a high pressure mercury UV lamp in a light dose of 300 mJ/cm² to manufacture a window for a display device.

### EVALUATION

Mechanical characteristics and flexibility of the windows for a display device according to Examples 1 to 3 and Comparative Examples 1 to 9 are evaluated.

The mechanical characteristics are evaluated by pencil hardness, a curl generation degree, and a scratch resistance, and the flexibility is evaluated through a 1R flexural property test.

The pencil hardness is evaluated by measuring pencil scratch hardness with a pencil hardness meter (an automatic pencil scratch hardness tester No. 553-M1, YASUDA SEIKI SEISAKUSHO Ltd.) and a Mitsubishi pencil according to ASTM D3363.

Specifically, the pencil hardness is evaluated as the highest pencil hardness by moving a pencil 10 millimeters (mm) back and forth five times on a window at 60 millimeters/minute (mm/min) with a vertical load of 1 kilogram (kg).

The curl generation degree is evaluated by cutting the windows into a size of 10 centimeters (cm)×10 cm and placing them on a glass plate and then, measuring their excitation lengths at each end.

The scratch resistance is evaluated by mounting a steel wool (#0000, Liberon Limited) on a friction tester (a vertical rubbing tester; COAD.108. Ocean Science), 100 times reciprocating the tester with a load of 1.5 kg on the windows, and counting the number of scratch thereon.

The 1R flexural property is evaluated by performing an appearance test on a folded place of the windows to check if a crack and/or a winkle is generated after respectively inserting the windows between two stainless steel plates and 20,000 times repetitively folding and unfolding the windows to have a curvature radius (r) of 1 mm.

The results are shown in Table 1.

TABLE 1

| | Thickness | | | | |
|---|---|---|---|---|---|
| | Upper protective | | | | |
| | layer/Lower | | | | |
| | protective layer | Pencil | Curl | | Flexural |
| | (μm) | hardness | (mm) | Scratch | property |
| Example 1 | 10/3 | 4H | 3 | ⊚ | pass |
| Example 2 | 25/3 | 4H | 2 | ⊚ | pass |
| Example 3 | 10/3 | 4H | 3 | ⊚ | pass |
| Comparative | 10/0 | 3H | 1 | Δ | pass |
| Example 1 | | | | | |
| Comparative | 0/10 | 4H | 30 | X | pass |
| Example 2 | | | | | |
| Comparative | 3/3 | 2H | 3 | X | pass |
| Example 3 | | | | | |
| Comparative | 35/3 | 3H | 2 | Δ | fail |
| Example 4 | | | | | |
| Comparative | 10/15 | 4H | 30 | ⊚ | fail |
| Example 5 | | | | | |
| Comparative | 10/3 | 3H | 7 | ⊚ | Pass |
| Example 6 | | | | | |
| Comparative | 10/3 | 4H | 30 | ⊚ | fail |
| Example 7 | | | | | |
| Comparative | 13 (Single | 3H | 20 | X | fail |
| Example 8 | protective layer) | | | | |
| Comparative | 10/3 | 4H | 30 | X | fail |
| Example 9 | | | | | |

* ⊚: less than or equal to 2 scratches
Δ: 3 or 4 scratches
X: greater than or equal to 5 scratches
* Pass: no crack/wrinkle, Fail: crack/wrinkle.

Referring to Table 1, the windows for a display device according to Examples 1 to 3 show improved flexibility and mechanical characteristics compared with the windows for a display device according to Comparative Examples 1 to 9.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A window for a display device, comprising:
a polymer substrate;
a first protective layer on the polymer substrate and comprising a cured product of a multi-functional urethane (meth)acrylate compound comprising six or more (meth)acrylate groups; and
a second protective layer on the first protective layer and comprising a cured product of epoxy-containing polysilsesquioxane;
wherein the second protective layer is thicker than the first protective layer, and
a thickness of the first protective layer ranges from about 0.1 μm to about 10 μm and a thickness of the second protective layer ranges from about 5 μm to about 30 μm.

2. The window for a display device of claim 1, wherein the first protective layer further comprises an inorganic nanostructure.

3. The window for a display device of claim 2, wherein the inorganic nanostructure is chemically bonded in the cured product of the multi-functional urethane (meth)acrylate compound.

4. The window for a display device of claim 1, wherein the multi-functional urethane (meth)acrylate compound has nine or more (meth)acrylate groups.

5. The window for a display device of claim 1, wherein the first protective layer comprises a silicon leveling agent or a cured product thereof.

6. The window for a display device of claim 1, wherein the epoxy-containing polysilsesquioxane comprises a glycidyl group, a glycidoxy group, an epoxy cyclohexyl group, an oxetanyl group, or a combination thereof.

7. The window for a display device of claim 1, wherein the second protective layer comprises a fluorine leveling agent or a cured product thereof.

8. The window for a display device of claim 1, wherein a sum of thicknesses of the first protective layer and the second protective layer is about 10 μm to about 30 μm.

9. The window for a display device of claim 1, wherein a thickness of the first protective layer ranges from about 2 μm to about 5 μm and a thickness of the second protective layer ranges from about 7 μm to about 30 μm.

10. The window for a display device of claim 1, wherein the polymer substrate comprises polyimide, polyamide, polyamideimide, polyethylene terephthalate, polyethylene naphthalate, polymethyl methacrylate, polycarbonate, a copolymer thereof, or a combination thereof.

11. The window for a display device of claim 1, wherein the polymer substrate has a thickness of about 25 μm to 100 μm.

12. A method of manufacturing a window for a display device, the method comprising:
coating a first composition comprising a multi-functional urethane (meth)acrylate compound comprising six or more (meth)acrylate groups, a first reaction initiator, and a first solvent on a polymer substrate and curing the first composition to form a first protective layer; and
coating a second composition comprising an epoxy-containing polysilsesquioxane, a second reaction initiator, and a second solvent on the first protective layer and curing the second composition to form a second protective layer,
wherein the second protective layer is thicker than the first protective layer, and
a thickness of the first protective layer ranges from about 0.1 μm to about 10 μm and a thickness of the second protective layer ranges from about 5 μm to about 30 μm.

13. The method of claim 12, wherein the first composition further comprises a (meth)acryl modified inorganic nanostructure.

14. The method of claim 12, wherein the first composition further comprises a silicon leveling agent.

15. The method of claim 12, wherein the second composition further comprises a fluorine leveling agent.

16. The method of claim 12, wherein the multi-functional urethane (meth)acrylate compound comprises nine or more (meth)acrylate groups, and
the epoxy-containing polysilsesquioxane comprises a glycidyl group, a glycidoxy group, an epoxy cyclohexyl group, an oxetanyl group, or a combination thereof.

17. A display device comprising:
a display panel; and
the window for a display device of claim 1.

18. The display device of claim 17, wherein the display panel is an organic light emitting display panel or a liquid crystal display panel.

19. The display device of claim 17, wherein the display panel is a bendable display panel, a foldable display panel, or a rollable display panel.

20. The display device of claim 17, further comprising a touch panel between the display panel and the window for a display device.
